(19) United States
(12) Patent Application Publication
(10) Pub. No.: US 2019/0357551 A1
(43) Pub. Date: Nov. 28, 2019

(54) BAKED FOOD PRODUCT WITH HIGH PROTEIN CONTENT

(71) Applicant: Nüber Food Limited, Sevenoaks, Kent (GB)

(72) Inventors: Gurpareet Singh BAINS, Bedford (GB); Giles Richard WHITMAN, Sevenoaks (GB)

(21) Appl. No.: 16/478,319

(22) PCT Filed: Jan. 16, 2018
(86) PCT No.: PCT/GB2018/050114

§ 371 Date: Jul. 16, 2019

(30) Foreign Application Priority Data
Jan. 17, 2017 (GB) 1700823.6
Jul. 24, 2017 (GB) 1711912.4

(51) Int. Cl. A21D 2/26; A21D 2/36; A21D 13/066; A23L 33/185

(52) U.S. Cl. CPC A21D 2/264; A23L 33/185; A21D 13/066; A21D 2/36

(57) ABSTRACT

In one aspect, baked food products with high protein content are provided. The baked food products include from 10 to 45% by dry ingredient weight algae flour, wherein the algae flour has a protein content of less than 50%; from 30 to 70% by dry ingredient weight fruit and/or vegetables; from 15 to 50% by dry ingredient weight protein source, wherein the protein source has a protein content of greater than or equal to 50% and is of non-meat origin; and less than 10% by dry ingredient weight other food ingredients; The baked food product has a protein content greater than 15%, and has a water activity of less than 0.8.

### TECHNICAL FIELD

The present invention relates to baked food products. In particular, the present invention relates to baked food products comprising algae flour.

### BACKGROUND

There is a consumer demand for snack food products in a convenient form that are readily carried around. Such products typically need to have a reasonably long storage life in order to be compatible with retail supply chains. Therefore, such products should have good storage stability.

There is also a consumer demand for food products with a high protein content, which contain whole food ingredients, and are processed to as little degree as possible. In particular, some consumers wish to avoid food products containing meat-based protein. Some consumers wish to avoid wheat flour and other flours that contain gluten. There is a consumer demand for gluten-free products.

Further, there is a consumer demand for healthier snack food products that are lower in sugar and fat than existing products, and that can provide a useful contribution to eating 5 portions of fruit and vegetables a day, as advised by the UK Government. Some healthier snack foods may contain no added sugar. In particular, there is a consumer demand for snack foods with a high protein content, and with low sugar and fat contents.

Further still, there is a consumer demand for food products containing fruit and/or vegetables wherein the food products have an extended shelf-life.

It is an object of the present invention to provide a baked food product that satisfies in whole or in part one or more of these consumer demands, and a method for making such a baked food product.

### SUMMARY

According to a first aspect of the present invention, there is provided a baked food product consisting of:

from 10 to 45% by dry ingredient weight algae flour, wherein the algae flour has a protein content of less than 50%;

from 30 to 70% by dry ingredient weight fruit and/or vegetables;

from 15 to 50% by dry ingredient weight protein source, wherein the protein source has a protein content of greater than or equal to 50% and is of non-meat origin; and

less than 10% by dry ingredient weight other food ingredients;

wherein the baked food product has a protein content greater than 15%, and has a water activity of less than 0.8.

2) A baked food product according to 1), wherein the baked food product is made from fruit and/or vegetable ingredients in particulate form in an amount of greater than or equal to 20% by dry weight of the fruit and/or vegetable ingredients.

3) A baked food product according to any of 1) or 2), wherein the baked food product has a sugar content of less than 50% by dry weight.

4) A baked food product according to any of 1) to 3), wherein the protein source comprises hemp, whole algal protein, rice protein (including brown rice protein), pea protein, whey protein (including whey protein isolate), soy protein (including soy protein isolate), or a combination thereof.

5) A baked food product according to any of 1) to 4), wherein the protein source is of non-animal origin.

6) A baked food product according to any of 1) to 5), wherein the fruit and/or vegetables include seeds in an amount of from 0 to 30% by dry weight of the fruit and/or vegetables.

7) A baked food product according to any of 1) to 6), wherein the fruit and/or vegetables contain fruit in an amount of less than 50% by dry weight of the fruit and/or vegetables.

8) A baked food product according to any of 1) to 7), wherein the fruit and/or vegetables consist of vegetables.

9) A baked food product according to any of 1) to 8), wherein the vegetables are selected from butternut squash, carrot, onion, parsnip, bell pepper, chili pepper, tomato, artichoke, asparagus, avocado, broccoli, cauliflower, potato, sweet potato, yam, pumpkin, marrow (including courgette), aubergine, cucumber, spring onion, chive, garlic, leek, beetroot, celery, endive, spinach, kale, seaweed, cabbage, Brussels sprouts, watercress, chard, fennel, olive, and combinations thereof.

10) A baked food product according to any of 1) to 7), wherein the fruit are selected from cranberry, goji berry, grape, cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate, and combinations thereof.

11) A baked food product according to any of 1) to 10), wherein the baked food product does not comprise wheat flour.

12) A baked food product according to any of 1) to 11), wherein the baked food product does not comprise egg.

13) A baked food product according to any of 1) to 13), wherein the baked food product does not comprise a binding/gelling agent.

14) A baked food product according to any of 1) to 13), wherein the baked food product has a water activity of less than 0.7.

15) A baked food product according to any of 1) to 14), wherein the baked food product is further provided with a coating.

16) A method of making a baked food product with a protein content of greater than 15%, the method comprising the steps of:

(a) mixing fruit and/or vegetable ingredients in an amount of from 30 to 70% by dry weight with algae flour in an amount of from 10 to 45% by dry weight and protein source in an amount of from 15 to 50% by dry weight to afford a mixture, wherein the protein source has a protein content greater than or equal to 50% and is of non-meat origin; and

(b) baking the mixture to afford a baked material having a water activity of less than 0.8;

wherein the mixture or baked material is formed into a food product shape before or after step (b) respectively, thereby providing a baked food product.

17) A method according to 16), wherein the mixture is formed into the food product shape before step (b).

18) A method according to 16), wherein the baked material is formed into the food product shape after step (b).

19) A method according to any of 16) to 18), wherein the fruit and/or vegetable ingredients consist of particulate ingredients and liquidised ingredients, and, in step (a), the particulate ingredients are first combined with the algae flour and protein source, and then the liquidised ingredients are added.

20) A method according to any of 16) to 19), wherein the fruit and/or vegetable ingredients consist of particulate ingredients.

21) A method according to any of 16) to 20), wherein the vegetable ingredients are selected from butternut squash, carrot, onion, parsnip, bell pepper, chili pepper, tomato, artichoke, asparagus, avocado, broccoli, cauliflower, potato, sweet potato, yam, pumpkin, marrow (including courgette), aubergine, cucumber, spring onion, chive, garlic, leek, beetroot, celery, endive, spinach, kale, seaweed, cabbage, Brussels sprouts, watercress, chard, fennel, olive, and combinations thereof.

22) A method according to any of 16) to 21), wherein the fruit ingredients are selected from cranberry, goji berry, grape, cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate, and combinations thereof.

23) A method according to any of 16) to 22), wherein the protein source comprises hemp, whole algal protein, brown rice protein, pea protein, whey protein (including whey protein isolate), soy protein (including soy protein isolate), or a combination thereof.

24) A method according to any of 16) to 23), wherein the baking is conducted at a temperature of from 30° C. to 150° C. and for a duration of from 60 mins to 1,800 mins.

25) A method according to any of 16) to 24), wherein the mixture has a moisture level of from 5 to 50%.

Further features and advantages of the invention will become apparent from the following description of preferred embodiments of the invention, given by way of example only.

### DETAILED DESCRIPTION

Unless otherwise specified, in the specification and claims, all percentages are percentages by weight and all temperatures are in degrees Centigrade (degrees Celsius).

One aspect of the present invention is a baked food product consisting of algae flour, fruit and/or vegetables, and optionally other food ingredients, wherein the baked food product has a water activity of less than 0.7.

Baked food product' as used herein refers to a product with a mixture of ingredients consumable by humans which has been subjected to a baking process. A baking process involves the application of heat in a heated air environment, for example in an oven, which cooks and dehydrates the mixture. In particular, baked food product may refer to a foodstuff which has been processed and formed. That is, during the manufacture of the food product, the mixture may be subjected to a forming process, such as moulding, pressing, deposition, extrusion, or a combination thereof, to provide a formed baked food product of the desired shape. Forming may further include cutting a moulded, pressed, deposited or extruded composition to provide a formed baked food product of the desired shape.

‘Baking’ or ‘baking process’ as used herein includes the application of heat in a heated air environment wherein the heated air environment is at a relatively low temperature. For example, baking includes the application of heat in a heated air environment at a temperature of around 30° C. In such examples, the baking process will predominantly comprise dehydration.

In many baked food products, a grain-derived flour component may need to be included to provide a product with acceptable flavour, mouthfeel, binding and texture. Alternatively or additionally, components comprising gluten may be included in such products to aid in binding. Therefore, many baked food products comprise wheat flour or other grain. A separate fat component is also routinely included. Surprisingly, it has been found that these conventional base components, including wheat flour, may be replaced entirely with algae flour to provide baked food products with satisfactory flavour, mouthfeel, binding and texture. These may have a lower carbohydrate and/or fat content than conventional baked food products.

Algae Flour

‘Algae flour’ or ‘algal flour’ as used herein refers to a whole-food ingredient deriving from algae. Alga sources suitable for the present invention include eukaryotic algae. The algae may be unicellular and/or non-motile. For example, the algae may be green algae, including Chlorophyta and Charophyta. In a preferred embodiment, the alga belongs to the phylum Chlorophyta. In a particularly preferred embodiment, the alga belongs to the genus Chlorella. Preferably, the alga is Chlorella protothecoides. These alga sources may be used as a starting material for an algae flour. For instance, the starting material for an algae flour may be a dried algae biomass, wherein the alga is an alga as described above.

‘Whole-food’ ingredient as used herein refers to an unprocessed product, or a processed product wherein none of the starting material components that are considered edible and palatable are discarded during the process; the whole-food ingredient comprises all of the components or derivatives of the components of the starting material that are considered edible and palatable. In the case of an algae ingredient, all of the components or derivatives of the components of the algae are included in the algae ingredient. In the case of a fruit or vegetable ingredient, all of the components or derivatives of the components of the relevant edible portion (leaf, fruit, stem, seed etc as is appropriate for the ingredient) of the fruit or vegetable ingredient is included. As needed or desired, the inedible or unpalatable parts of the fruit and/or vegetable ingredient may be removed in whole or in part, for example the skin, peel, pips, stones and the like. Otherwise, however, all of the components or derivatives of the components of the edible and palatable part of the fruit and/or vegetable ingredient are retained after any processing. “Derivatives of the components” indicates that the composition of an ingredient may change to some degree during processing, and in particular during baking or other cooking process.

The algae flour may be produced by any appropriate method. For example, a dried algae biomass may be dry milled to provide an algae flour. Alternatively, an aqueous suspension may be lysed, and the resulting mass dried to provide an algae flour.

Suitable algae flours to be used in the present invention may be high in lipids. In a preferred embodiment, the algae flour is a GRAS ingredient (Generally Recognised as Safe by the Food and Drug Administration). Suitable algal flours may be obtained from the vendor AlgaVia®. AlgaVia® lipid-rich algal flour is suitable for use in the present invention. Lipid-rich algal flours may be provided by inducing lipid production during by limiting inorganic nitrogen during the latter part of alga fermentation.

The algae flour may have a fat content of from 25 to 75% by dry weight, or from 30 to 70%, or from 35 to 65%, or from 40 to 60%. In some embodiments the algae flour may have a fat content of less than 75% by dry weight, or 70%, or 65%, or 60%, or 55% or 50%. In some embodiments the algae flour may have a fat content of more than 25% by dry weight, or 30%, or 35%, or 40%, or 45%. The term “fat” is inclusive of oils and refers to glyceryl esters of fatty acids. Accordingly, ‘fat’ and ‘oil’ may be used interchangeably herein.

The algae flour has a protein content of less than 50% by dry weight. The algae flour may have a protein content of less than 40%, 30%, 20%, or 10% by dry weight. The algae flour may have a protein content of greater than 0%, 1%, 5%, 10% or 20% by dry weight. The algae flour may have a protein content of from 0% to 50%, 1% to 40%, 1% to 30%, or 5% to 20% by dry weight. For the avoidance of doubt, algae with a protein content of equal to or greater than 50% is not included within the definition of algae flour as used herein, even if said algae is ground and has a particulate form corresponding to flour. Such algae instead corresponds to ‘whole algal protein’, as discussed hereinbelow.

The baked food product may include a fat component. As used herein, ‘fat component’ refers to glyceryl esters of fatty acids other than any present in the algae flour. Suitable fat components are food grade water insoluble fats and oils from animal and vegetable sources which can be liquids or solids at room temperature. Either a single fat or oil or mixtures of fats and/or oils may be employed in any suitable amount.

Suitable fats include butter, shortening, hydrogenated oil, lard, tallow, and the like, and vegetable oils such as soybean oil, cottonseed oil, coconut oil, rapeseed oil, peanut oil, olive oil, palm oil, sunflower seed oil, rice bran oil, corn oil, sesame seed oil. The fat content of the algae flour may obviate the need to include a fat component in the baked food product. Accordingly, the present invention may provide a baked food product with acceptable flavour, mouthfeel, binding and texture which essentially does not comprise a fat component. Accordingly, in one embodiment, the baked food product essentially does not comprise any further fat components.

The algae flour may constitute 10 to 45% of the baked food product by dry ingredient weight, or 10 to 40% or 15 to 35%. In some embodiments, the baked food product comprises algae flour in an amount of less than 40% of the baked food product by dry ingredient weight, or less than 38%, or less than 35%, or less than 30%, or less than 25%. In some embodiments, the baked food product comprises algae flour in an amount of more than 15% of the baked food product by dry ingredient weight, or more than 20%, or more than 25%, or more than 30%, or more than 35%.

Fruit and/or Vegetables

The algae flour is to be combined with fruit and/or vegetable ingredients. As used herein, “fruit and/or vegetable” is to be understood in the commercial meaning of fruit and vegetables as those products which are conventionally categorised as greengrocer's products, and not in the botanical sense. In particular, grains are not included in the meaning, and especially are not included in ground form or as flour. Grains may however be included in small quantities as “other food ingredients” as specified; however preferably they are not present in the baked food product of the present invention.

The fruit and/or vegetable ingredients may comprise any fruit and/or vegetable suitable for human consumption, and may comprise one or more different fruit and/or vegetables.

The distinction between fruit and vegetable herein follows the conventional categorisation of greengrocer's products. The term “fruit” as used herein refers to culinary fruit, typically referring to products with a sweet or sour taste, and/or products which are conventionally used in sweet dishes such as a dessert course of a meal. Accordingly, the term “fruit” as used herein may include products which would not be classed as fruit in a botanical sense, such as rhubarb.

Particular fruit suitable for use in the present invention include cranberry, goji berry, grape (for example in the form of raisin, sultana, or currant), cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate, and combinations thereof.

In some embodiments, the fruit comprise cranberry, goji berry, grape (for example in the form of raisin, sultana, or currant), cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate, or a combination thereof.

In some embodiments, the fruit consist of cranberry, goji berry, grape (for example in the form of raisin, sultana, or currant), cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate, or a combination thereof

The term “vegetable” as used herein refers to culinary vegetables, typically referring to products with a generally savoury or less sweet taste, and/or products which are conventionally used in savoury dishes such as a main course of a meal. Accordingly, the term “vegetable” as used herein may include products which would not be classed as vegetables in a botanical sense, such as avocado, aubergine, capsicum (including bell pepper and chilli pepper), cucumber, olive, squash (including butternut squash, marrow, courgette, and pumpkin), and tomato. However, for the avoidance of doubt, the term “vegetable” as used herein does not include grains.

Particular vegetables suitable for use in the present invention include butternut squash (for example as purée), carrot, onion (for example as shallot), parsnip, bell pepper, chili pepper, tomato (for example as purée, granules, passata, or sundried tomatoes), or a combination thereof. Further vegetables suitable for use include artichoke, asparagus, avocado, broccoli, cauliflower, potato, sweet potato, yam, pumpkin, marrow (including courgette, also referred to as zucchini), aubergine, cucumber, spring onion, chive, garlic, leek, beetroot, celery, endive, spinach, kale, seaweed, cabbage, Brussels sprouts, watercress, chard, fennel, olive, and combinations thereof.

In some embodiments, the vegetables comprise butternut squash (for example as purée), carrot, onion (for example as shallot), parsnip, bell pepper, chili pepper, tomato (for example as purée, granules, passata, or sundried tomatoes), artichoke, asparagus, avocado, broccoli, cauliflower, potato, sweet potato, yam, pumpkin, marrow (including courgette, also referred to as zucchini), aubergine, cucumber, spring onion, chive, garlic, leek, beetroot, celery, endive, spinach, kale, seaweed, cabbage, Brussels sprouts, watercress, chard, fennel, olive, or a combination thereof.

In some embodiments, the vegetables consist of butternut squash (for example as purée), carrot, onion (for example as shallot), parsnip, bell pepper, chili pepper, tomato (for example as purée, granules, passata, or sundried tomatoes), artichoke, asparagus, avocado, broccoli, cauliflower, potato, sweet potato, yam, pumpkin, marrow (including courgette, also referred to as zucchini), aubergine, cucumber, spring onion, chive, garlic, leek, beetroot, celery, endive, spinach, kale, seaweed, cabbage, Brussels sprouts, watercress, chard, fennel, olive, or a combination thereof.

The fruit and/or vegetable component of the baked food product of the present invention may optionally include seeds. ‘Seeds’ as used herein refers to edible seeds including pulses (legumes), nuts, and other seeds, but excludes grains (cereals). For the avoidance of doubt, the fruit and/or vegetable component, including seeds when present, does not include grains.

In some embodiments of the invention, the fruit and/or vegetables do not include seeds: seeds may be absent from the fruit and/or vegetable ingredients. Accordingly, in some embodiments, the fruit and/or vegetable ingredients do not comprise seeds. However, in these embodiments, seeds may be included in the baked food product as “other food ingredients”.

In other embodiments, seeds are absent from the baked food product entirely; seeds are absent from both the fruit and/or vegetable ingredients and the “other food ingredients”. Accordingly, in some embodiments, the fruit and/or vegetable ingredients do not comprise seeds, and the “other food ingredients” do not comprise seeds; in these embodiments, the baked food product does not comprise seeds.

However, in other embodiments, the fruit and/or vegetable ingredients may include seeds. In such embodiments, the fruit and/or vegetable ingredients preferably include seeds in an amount of less than 30%. For embodiments wherein the fruit and/or vegetable ingredients include seeds, some or all of the seeds may be whole or split: that is, they are not ground. In some embodiments, some or all of the seeds may be ground. The fruit and/or vegetable ingredients may comprise seeds, when present, in an amount of less than or equal to 30% of the fruit and/or vegetable ingredients by dry weight, or less than or equal to 25%, or 20%, or 15%, or 10%, or 5%, or 1%.

The seeds of the fruit and/or vegetable ingredients, when present, may include pulses, nuts, other seeds, and a combination thereof. As used herein, the terms ‘pulses’, ‘nuts’ and ‘seeds’ are used in a culinary sense. Suitable pulses may include kidney beans, navy beans, pinto beans, haricot beans, lima beans, butter beans, mung beans, runner beans, ricebeans, broad beans, field beans, soybean, garden peas, field peas, corn kernels (including sweetcorn) chickpeas, black-eyed peas, lentils, and the like. In one embodiment, the pulses may comprise lentils. Suitable nuts may include almonds, Brazil nuts, cashew nuts, macadamia nuts, chestnuts, pecans, peanuts, pine nuts, pistachio, walnuts, and the like. ‘Other seeds’ include other edible seeds which are not classed as pulses or nuts, such as chia seed, flax seed, lotus seed, poppy seed, sesame seed, sunflower seed, pumpkin seed, hemp seeds, and the like. For the avoidance of doubt, hemp seeds (such as hulled hemp seeds) which have a protein content of less than 50% are included in the definition of ‘other seeds’; hemp products which have a protein content of 50% or more are included in the definition of ‘protein source’. ‘Pulse’ as used herein includes soybean and soybean products which have a protein content of less than 50%; soybean products or derivatives which have a protein content of 50% or more are included in the definition of ‘protein source’.

The fruit and/or vegetables (and in particular, the seeds, when present) have a protein content of less than 50%. For the avoidance of doubt, fruit and/or vegetables, including seeds, with a protein content of greater than or equal to 50% are not included within the definition of fruit and/or vegetables. Such products instead correspond to the protein source discussed hereinbelow.

In embodiments wherein the fruit and/or vegetables comprise seeds, the seeds may comprise pulses, nuts, other seeds, a combination of pulses and nuts, a combination of pulses and other seeds, a combination of nuts and other seeds or a combination of pulses, nuts and other seeds. In a particular embodiment, the seeds may consist of pulses, nuts, other seeds, a combination of pulses and nuts, a combination of pulses and other seeds or a combination of nuts and other seeds. Accordingly, in some embodiments wherein the fruit and/or vegetables include seeds, the fruit and/or vegetables do not comprise pulses, or nuts, or seeds, or pulses and nuts, or pulses and seeds, or nuts and seeds. Further, the baked food product does not comprise pulses, or nuts, or seeds, or pulses and nuts, or pulses and seeds, or nuts and seeds. In a particular example, the baked food product does not comprise seeds.

In some embodiments, the fruit and/or vegetable ingredients may comprise pulses in an amount of less than or equal to 30% of the fruit and/or vegetable ingredients by dry weight, or less than or equal to 25%, or 20%, or 15%, or 10%, or 5%, or 1%. In some embodiments, the fruit and/or vegetable ingredients do not comprise pulses. In a further embodiment, the baked food product does not comprise pulses.

In further embodiments, the baked food product may comprise pulses in an amount of less than or equal to 15% by dry weight, or 10%, or 5%, or 1%. In some embodiments, the baked food product does not comprise pulses.

In some embodiments, the fruit and/or vegetable ingredients may comprise nuts in an amount of less than or equal to 30% of the fruit and/or vegetable ingredients by dry weight, or less than or equal to 25%, or 20%, or 15%, or 10%, or 5%, or 1%. In some embodiments, the fruit and/or vegetable ingredients do not comprise nuts. In a further embodiment, the baked food product does not comprise nuts.

In further embodiments, the baked food product may comprise nuts in an amount of less than or equal to 15% by dry weight, or 10%, or 5%, or 1%. In some embodiments, the baked food product does not comprise nuts.

In some embodiments, the fruit and/or vegetable ingredients may comprise other seeds in an amount of less than or equal to 30% of the fruit and/or vegetable ingredients by dry weight, or less than or equal to 25%, or 20%, or 15%, or 10%, or 5%, or 1%. In some embodiments, the fruit and/or vegetable ingredients do not comprise other seeds. In a further embodiment, the baked food product does not comprise other seeds.

In further embodiments, the baked food product may comprise other seeds in an amount of less than or equal to 15% by dry weight, or 10%, or 5%, or 1%. In some embodiments, the baked food product does not comprise other seeds.

In some embodiments wherein seeds are present in the baked food product, the seeds may be partially or entirely ground. For example, the seeds may consist of ground pulses and/or nuts and/or other seeds. Ground seeds may comprise ground almonds, gram flour, soy flour and the like. In some embodiments, the seeds may comprise or consist of ground almonds, gram flour, soy flour, cornmeal (also referred to as maize flour) and combinations thereof.

In other embodiments, the seeds are not ground. For example, the seeds may have a mean particle size greater than that of a conventional flour. ‘Particle size’ as used herein refers to the average of the longest and shortest dimension of a particle. In some embodiments, the mean particle size of the seeds may be greater than or equal to 0.5 mm, 0.75 mm, 1 mm, 1.5 mm, 2 mm, 2.5 mm, or 5 mm. In some embodiments, the seeds comprise entire, intact seeds. In further embodiments, the seeds consist of entire, intact seeds.

As employed herein, “fruit and/or vegetable” and “fruit and/or vegetable ingredients” are used with similar and cognate meaning and sometimes interchangeably, but the former term focuses on the original state before any processing and as present in the baked food product, while the latter term focuses on the state as starting materials for the method according to the present invention, thus after any initial processing but before mixing and baking.

The fruit and/or vegetable ingredients as used herein are generally whole food ingredients as defined herein so that “fruit and/or vegetable” as used herein contains all of the components or derivatives of the components of the starting material that are considered edible and palatable. As needed or desired, the inedible or unpalatable parts of the fruit and/or vegetable ingredient may be removed in whole or in part, for example the skin, peel, pips, stones and the like. Otherwise, however, all of the components or derivatives of the components of the edible and palatable part of the fruit and/or vegetable ingredient are retained in the baked food product after any processing. Accordingly, not included within the meaning of fruit and/or vegetable ingredients are fruit juices, refined sugars, colourings, flavourings, and the like.

Said fruit and/or vegetable ingredients may be provided in any appropriate form. For example, the fruit and/or vegetable ingredients may be provided as particles of fruit and/or vegetable. That is, the fruit and/or vegetable ingredients may be provided in particulate form. Particulate fruit and/or vegetable ingredients generally do not comprise a continuous phase and are distinguished from the liquidised ingredients discussed below. Particulate fruit and/or vegetable ingredients include entire, intact fruit and/or vegetables, and pieces of fruit and/or vegetable. Pieces of fruit and/or vegetable may be provided by cutting, chopping, grinding, or grating fruit and/or vegetables, for example.

In a particular embodiment, at least some of the fruit and/or vegetables are dehydrated, for example: grape provided as raisin, sultana or currant; tomato provided as sundried tomato or dehydrated tomato granules; dehydrated carrot; dehydrated parsnip; or dehydrated bell pepper. The fruit and/or vegetables may be dehydrated according to any appropriate manner, including air-drying, sun-drying, smoking, wind drying, freeze-drying or passing through a food dehydrator.

In some embodiments, particulate fruit and/or vegetable ingredients may be provided as entire, intact ingredients. For example, grape may be provided as an entire raisin, which has not been chopped or further processed. In other embodiment, particulate fruit and/or vegetable ingredients may be provided as pieces of fruit and/or vegetable obtained by cutting, chopping, or grating of a fruit and/or vegetable. For example, a bell pepper may be cut or chopped to provide smaller pieces of bell pepper suitable for including in a baked food product according to the present invention. In some embodiments, the baked food product of the present invention is preferably of a size suitable for a user to hold in one hand—in such an embodiment, including an entire, intact bell pepper may not be appropriate, for example. In a preferred embodiment, the baked food product comprises at least some ingredients which are particulate.

In some embodiments, the fruit and/or vegetable may be dehydrated and cut, chopped, or grated, for example, to provide particulate ingredients. In these embodiments, the fruit and/or vegetable ingredient may be prepared by dehydrating a fruit or vegetable, and then cutting, chopping, or grating the dehydrated fruit or vegetable to provide pieces of dehydrated fruit or vegetable. Alternatively, the fruit and/or vegetable ingredient may be prepared by cutting, chopping, or grating the fruit or vegetable, and then dehydrating the pieces of fruit or vegetable to provide pieces of dehydrated fruit or vegetable. Ingredients processed in this manner may be provided as granules or flakes, for example.

In some embodiments, particulate fruit and/or vegetable ingredients may be provided as a powder, or flour. For example, the fruit and/or vegetable ingredients may be ground. In these embodiments, the fruit and/or vegetable ingredient may be prepared by dehydrating a fruit or vegetable, and then grinding the dehydrated fruit or vegetable to provide a fruit and/or vegetable flour or powder.

In some embodiments, particulate fruit and/or vegetable ingredients are not of very small particle size. Thus, in some embodiments, the fruit and/or vegetable ingredients are not ground. For example, at least one of the particulate fruit and/or vegetable ingredients may have a mean particle size greater than that of a conventional flour. In some embodiments, the mean particle size of at least one of the particulate fruit and/or vegetable ingredients may be greater than or equal to 0.5 mm, 0.75 mm, 1 mm, 1.5 mm, 2 mm, 2.5 mm, or 5 mm. In some embodiments, the mean particle size of at least one of the particulate fruit and/or vegetable ingredients may be less than or equal to 20 mm, 15 mm, 10 mm, 5 mm, 2.5 mm, 2 mm, 1.5 mm, or 1 mm. In some embodiments, the mean particle size of at least one of the particulate fruit and/or vegetable ingredients may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In some embodiments, more than one of the particulate fruit and/or vegetable ingredients may have an overall mean particle size greater than that of a conventional flour. In some embodiments, the mean particle size of at least two, three, four or five of the particulate fruit and/or vegetable ingredients may be greater than or equal to 0.5 mm, 0.75 mm, 1 mm, 1.5 mm, 2 mm, 2.5 mm, or 5 mm. In some embodiments, the mean particle size of at least two, three, four or five of the fruit and/or vegetable ingredients may be less than or equal to 20 mm, 15 mm, 10 mm, 5 mm, 2.5 mm, 2 mm, 1.5 mm, or 1 mm. In some embodiments, the mean particle size of at least two, three, four or five of the fruit and/or vegetable ingredients may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In some embodiments, each of the particulate fruit and/or vegetable ingredients may have a mean particle size greater than or equal to 0.5 mm, 0.75 mm, 1 mm, 1.5 mm, 2 mm, 2.5 mm, or 5 mm. In some embodiments, the mean particle size of each of the particulate fruit and/or vegetable ingredients may be less than or equal to 20 mm, 15 mm, 10 mm, 5 mm, 2.5 mm, 2 mm, 1.5 mm, or 1 mm. In some embodiments, the mean particle size of each of the particulate fruit and/or vegetable ingredients may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In some embodiments, the particle size of at least 20%, 30%, 40%, 50%, 60%, 70%, 80%, or 90% of the particulate fruit and/or vegetable ingredients may be greater than or equal to 0.5 mm, 0.75 mm, 1 mm, 1.5 mm, 2 mm, 2.5 mm, or 5 mm. In some embodiments, the particle size of at least 20%, 30%, 40%, 50%, 60%, 70%, 80%, or 90% of the particulate fruit and/or vegetable ingredients may be less than or equal to 20 mm, 15 mm, 10 mm, 5 mm, 2.5 mm, 2 mm, 1.5 mm, or 1 mm. In some embodiments, the particle size of at least 20%, 30%, 40%, 50%, 60%, 70%, 80%, or 90% of the particulate fruit and/or vegetable ingredients may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In some embodiments, the mean particle size of all of the particulate fruit and/or vegetable ingredients taken together may be greater than or equal to 0.5 mm, 0.75 mm, 1 mm, 1.5 mm, 2 mm, 2.5 mm, or 5 mm. In some embodiments, the mean particle size of all of the particulate fruit and/or vegetable ingredients taken together may be less than or equal to 20 mm, 15 mm, 10 mm, 5 mm, 2.5 mm, 2 mm, 1.5 mm, or 1 mm. In some embodiments, the mean particle size of all of the particulate fruit and/or vegetable ingredients taken together may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

It follows that in some embodiments, the mean particle size of fruit and/or vegetables in the baked food product may be greater than that of conventional flour. For example, the particle size of at least 20%, 30%, 40%, 50%, 60%, 70%, 80%, or 90% of the fruit and/or vegetables in the baked food product may be greater than or equal to 0.5 mm, 0.75 mm, 1 mm, 1.5 mm, 2 mm, 2.5 mm, or 5 mm. In some embodiments, the particle size of at least 20%, 30%, 40%, 50%, 60%, 70%, 80%, or 90% of the fruit and/or vegetables in the baked food product may be less than or equal to 20 mm, 15 mm, 10 mm, 5 mm, 2.5 mm, 2 mm, 1.5 mm, or 1 mm. In some embodiments, the particle size of at least 20%, 30%, 40%, 50%, 60%, 70%, 80%, or 90% of the fruit and/or vegetables in the baked food product may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm. In some embodiments, the mean particle size of all of the fruit and/or vegetables in the baked food product taken together may be greater than or equal to 0.5 mm, 0.75 mm, 1 mm, 1.5 mm, 2 mm, 2.5 mm, or 5 mm. In some embodiments, the mean particle size of all of the fruit and/or vegetable ingredients in the baked food product take together may be less than or equal to 20 mm, 15 mm, 10 mm, 5 mm, 2.5 mm, 2 mm, 1.5 mm, or 1 mm. In some embodiments, the mean particle size of all of the fruit and/or vegetable ingredients in the baked food product take together may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In some embodiments, some fruit and/or vegetable ingredients may be provided in a liquidised form. Such ingredients have a continuous phase. That is, the fruit and/or vegetable may have been liquidised to provide a fruit and/or vegetable ingredient with a substantially uniform texture, and/or wherein any particulate matter is dispersed in a continuous phase. In preferred embodiments, the liquidised fruit and/or vegetable ingredient is a whole-food ingredient—the inedible or unpalatable parts of the fruit and/or vegetable ingredient may be removed in whole or in part, for example the skin, peel, pips, stones and the like. Otherwise, however, all of the components or derivatives of the components of the edible and palatable part of the fruit and/or vegetable are retained after the moderate mechanical processing. Examples of whole-food liquidised fruit and/or vegetable ingredients include pulp, passata, purée, and the like. For the avoidance of doubt, whole-food liquidised fruit and/or vegetable ingredients do not include presses or juices from concentrate.

In some embodiments, all of the fruit and/or vegetable ingredients are provided as (optionally dehydrated) particles. That is, as entire fruit and/or vegetables or as pieces of fruit and/or vegetable. In some embodiments, some of the fruit and/or vegetable ingredients are provided as (optionally dehydrated) particles (that is, as entire fruit and/or vegetables or as pieces of fruit and/or vegetable), and some of the fruit and/or vegetable ingredients are provided as liquidised ingredients. In some embodiments, the fruit and/or vegetable ingredients are not solely provided as liquidised ingredients.

The fruit and/or vegetable ingredients may comprise particulate and liquidised ingredients in any appropriate amount. In some examples, the fruit and/or vegetable ingredients may comprise particulate ingredients in an amount of greater than or equal to 20%, or 30%, or 40%, or 50%, or 60%, or 70%, or 80%, or 90% by dry weight of the ingredients. In other examples, the fruit and/or vegetable ingredients comprise particulate ingredients in an amount of less than 90%, or 80%, or 70%, or 60%, or 50%, or 40% by dry weight of the ingredients.

In some examples, the fruit and/or vegetable ingredients may comprise liquidised ingredients in an amount of greater than or equal to 1%, or 5%, or 10%, or 20%, or 30%, or 40%, or 50% by dry weight of the ingredients. In other examples, the fruit and/or vegetable ingredients comprise liquidised ingredients in an amount of less than 50%, or 40%, or 30%, or 20%, or 10%, or 5%, or 1% by dry weight of the ingredients.

In a preferred embodiment, the fruit and/or vegetable ingredients consist of particulate and liquidised ingredients, wherein particulate ingredients form at least 50%, or 60%, or 70%, or 80%, or 90% of the fruit and/or vegetable ingredients by dry weight.

In another embodiment, the fruit and/or vegetable ingredients consist of particulate ingredients (that is, entire, intact ingredients and/or cut, chopped, ground or grated ingredients). That is, the fruit and/or vegetable ingredients do not include liquidised ingredients. The particulate ingredients may be fruit and/or vegetables in dehydrated form, or may be fruit and/or vegetables in a mix of dehydrated form and non-dehydrated form, or fruit and/or vegetables in non-dehydrated form.

In some embodiments, some or all of the fruit and/or vegetable ingredients may be provided as raw ingredients. That is, some or all of the fruit and/or vegetable ingredients may not have been cooked or in any way treated so as to irreversibly denature enzymes therein prior to their use in the method of the present invention. Raw fruit and/or vegetable ingredients include dried or dehydrated fruit and/or vegetable ingredients which have not been cooked.

Fruit and/or vegetable ingredients used in relation to the present invention preferably do not include highly processed fruit and/or vegetables, such as canned or cooked fruit and/or vegetables.

The fruit and/or vegetable ingredients may provide 30 to 70% of the baked food product by dry ingredient weight, or 35 to 65%. In some embodiments, the baked food product comprises fruit and/or vegetable ingredients in an amount of less than 70% of the baked food product by dry ingredient weight, or less than 65%, or less than 60%, or less than 55%. In some embodiments, the baked food product comprises fruit and/or vegetable ingredients in an amount of more than 30% of the baked food product by dry ingredient weight, or more than 35%, or more than 40%, or more than 45%, or more than 50%, or more than 55%, or more than 60%, or more than 65%.

In some embodiments, vegetable ingredients may provide 30 to 70% of the baked food product by dry ingredient weight, or 35 to 65%. In some embodiments, the baked food product comprises vegetables in an amount of less than 70% of the baked food product by dry ingredient weight, or less than 65%, or less than 60%, or less than 55%. In some embodiments, the baked food product comprises vegetables in an amount of more than 30% of the baked food product by dry ingredient weight, or more than 35%, or more than 40%, or more than 45%, or more than 50%, or more than 55%, or more than 60%, or more than 65%

In some embodiments, fruit ingredients may provide 30 to 70% of the baked food product by dry ingredient weight, or 35 to 65%. In some embodiments, the baked food product comprises fruit in an amount of less than 70% of the baked food product by dry ingredient weight, or less than 65%, or less than 60%, or less than 55%, or less than 50%, or less than 45%, or less than 40%, or less than 35%, or less than 30%, or less than 25%, or less than 20%, or less than 15%, or less than 10%, or less than 5%.

In some embodiments, the fruit and/or vegetables of the baked food product may be mostly formed of vegetables. For example, the fruit and/or vegetables of the baked food product may comprise vegetables in an amount of more than 50% by dry weight of the fruit and/or vegetables, or more than 55%, or more than 60, or more than 65%, or more than 70%, or more than 75%, or more than 80%, or more than 85%, or more than 90%, or more than 95%. The fruit and/or vegetables of the baked food product may comprise fruit in an amount of less than 50% by dry weight of the fruit and/or vegetables, or less than 45%, or less than 40%, or less than 35%, or less than 30%, or less than 25%, or less than 20%, or less than 15%, or less than 10%, or less than 5%. In some embodiments, the baked food product does not comprise fruit. In such embodiments, the baked food product comprises vegetables in the absence of fruit. Baked food products according to these embodiments may comprise vegetables in any of the amounts given hereinabove. Baked food products according to the present invention containing algae flour and vegetables in the absence of fruit may have an unexpectedly desirable flavour, mouthfeel, binding and/or texture.

The baked food product of the present invention may have any sugar content. In this context, ‘sugar’ refers to the all of the mono- and di-saccharides contained in a product, excluding polyols, as defined in EU Regulation No. 1169/2011, and may correspond to the “Total Sugars” content which is displayed on food packaging in the EU. However, as defined herein, ‘sugar content’ is expressed on a dry weight basis. This value includes monosaccharides such as glucose, fructose and galactose, and disaccharides such as sucrose, maltose, and lactose. This value includes mono- and disaccharides provided by the fruit and/or vegetable ingredients, or “other food ingredients”. For the avoidance of doubt, this value does not include any contribution from oligo- or polysaccharides present in the food, or any polyols such as maltitol, sorbitol, xylitol, erythritol, or isomalt present in the food. Further, this value does not refer to added sugar alone, but to sugars present in the fruit and/or vegetables in combination with any added sugar (if present).

In some examples, the baked food product may have a sugar content of from 0 to 50%, or 5 to 50%, or 10 to 45%, or 15 to 40%, or 20 to 35% by dry weight. In some examples, the baked food product may have a sugar content of less than 50%, or less than 45%, or less than 40%, or less than 35%, or less than 30%, or less than 25%, or less than 20%, or less than 15%, or less than 10%, or less than 5% by dry weight. In some examples, the baked food product may have a sugar content of more than 1%, or more than 5%, or more than 10%, or more than 15%, or more than 20%, or more than 25%, or more than 30%, or more than 35%, or more than 40%, or more than 45%, or more than 50% by dry weight. Surprisingly, baked food products according to the present invention may have a desirable flavour, mouthfeel, binding and/or texture with a low sugar content. In particular, baked food products according to the present invention containing algae flour and vegetables in the absence of fruit and/or sweetener with a low sugar content may have a desirable flavour, mouthfeel, binding and/or texture.

In some examples, the fruit and/or vegetable ingredients of the baked food product taken together may have a sugar content of from of from 0 to 70%, or 5 to 60%, or 10 to 50%, or 15 to 40%, or 20 to 35% by dry weight. In some examples, the fruit and/or vegetable ingredients of the baked food product taken together may have a sugar content of less than 70%, or less than 65%, or less than 60%, or less than 55%, or less than 50%, or less than 45%, or less than 40%, or less than 35%, or less than 30%, or less than 25%, or less than 20%, or less than 15%, or less than 10%, or less than 5% by dry weight. In some examples, the fruit and/or vegetable ingredients of the baked food product taken together may have a sugar content of more than 1%, or more than 5%, or more than 10%, or more than 15%, or more than 20%, or more than 25%, or more than 30%, or more than 35%, or more than 40%, or more than 45%, or more than 50% by dry weight.

In some examples, each fruit and/or vegetable ingredient of the baked food product may have a sugar content of from of from 0 to 70%, or 5 to 60%, or 10 to 50%, or 15 to 40%, or 20 to 35% by dry weight. In some examples, the baked food product may have a sugar content of less than 70%, or less than 65%, or less than 60%, or less than 55%, or less than 50%, or less than 45%, or less than 40%, or less than 35%, or less than 30%, or less than 25%, or less than 20%, or less than 15%, or less than 10%, or less than 5% by dry weight. In some examples, the baked food product may have a sugar content of more than 1%, or more than 5%, or more than 10%, or more than 15%, or more than 20%, or more than 25%, or more than 30%, or more than 35%, or more than 40%, or more than 45%, or more than 50% by dry weight.

In examples which include one or more liquidised fruit and/or vegetable ingredients, the sugar content of the liquidised fruit and/or vegetable component(s) taken together may be from 0 to 70%, or 5 to 60%, or 10 to 50%, or 15 to 40%, or 20 to 35% by dry weight. In some examples, the sugar content of the liquidised fruit and/or vegetable component(s) taken together may be less than 70%, or less than 65%, or less than 60%, or less than 55%, or less than 50%, or less than 45%, or less than 40%, or less than 35%, or less than 30%, or less than 25%, or less than 20%, or less than 15%, or less than 10%, or less than 5% by dry weight. In some examples, the sugar content of the liquidised fruit and/or vegetable component(s) taken together may be more than 1%, or more than 5%, or more than 10%, or more than 15%, or more than 20%, or more than 25%, or more than 30%, or more than 35%, or more than 40%, or more than 45%, or more than 50% by dry weight.

Protein Source

The baked food product comprises protein source, in an amount of from 15 to 50% by dry ingredient weight. As used herein, ‘protein’ generally refers to naturally occurring and synthetic polypeptides having molecular weights greater than approximately 10000 daltons, as defined by the International Union of Pure and Applied Chemistry.

The baked food product comprises protein source in an amount of from 15 to 50% by dry ingredient weight. In some examples, the baked food product may comprise protein source in an amount greater than or equal to 20%, 25%, 30%, 35%, 40%, or 45% by dry ingredient weight. In some examples, the baked food product may comprise protein source in an amount less than 45%, 40%, 35%, 30%, 25%, or 20% by dry ingredient weight. In some examples, the baked food product may comprise protein source in an amount of from 15 to 40%, or 18 to 35% by dry ingredient weight.

Protein source of the present invention has a protein content of greater than or equal to 50% by dry weight. Any ingredient with a protein content of greater than or equal to 50% which is present in the baked food product of the present invention is referred to as “protein source”, and is not included within any other component, including “other food ingredients”. In embodiments wherein the protein source contains a plurality of components, each component has a protein content of greater than or equal to 50%.

In some examples, the protein source may have a protein content of greater than or equal to 55%, 60%, 65%, 70%, 75%, 80%, 85%, or 90% by dry weight. In some examples, the protein source may have a protein content of less 100%, 98%, 95%, 90%, 85%, 80%, 75%, 70%, 65%, or 60% by dry weight. In some examples, the protein source may have a protein content of from 50 to 98%, or 55 to 95%, or 60 to 90% by dry weight. In some examples, the protein source may be a protein concentrate (which generally refers to processed protein sources, the processed protein sources having a protein content of at least 70% by dry weight), or a protein isolate (which generally refers to processed protein sources, the processed protein source having a protein content of at least 90% by dry weight).

In this context, ‘protein content’ corresponds to the values labelled ‘protein’ in the ‘Nutritional Information’ section in food packaging. In Europe, this value is defined according to EU Regulation No. 1169/2011, and generally means the protein content calculated using the formula:

Protein content=total Kjeldahl nitrogen×6.25

The total Kjeldahl nitrogen, and thus the protein content, may be measured using any appropriate apparatus according to any appropriate method. For example, the total Kjeldahl nitrogen may be measured with a LECO CNS-2000 Nitrogen Analyzer (LECO Corporation, St Joseph, Mich., U.S.A., Model No. 602-00-500). The protein content of a baked food product comprising a plurality of ingredients may be calculated by summing the protein content values provided on the food packaging of each ingredient, each protein content value being weighted according to the amount of each ingredient present in the bar.

Generally, the protein content may be determined according to any appropriate standard protocol, including, but not limited to, AOAC 979.09, AOAC 945.18, AOAC 920.87, ISO 20483:2006, AOAC 981.10, AOAC 991.20, AOAC 930.29, AOAC 950.48, AOCS Ac 4-91, AOCS Bc 4-91, AOAC 990.03, and AOAC 984.13.

Protein sources of the present invention are of non-meat origin. That is, they have not been obtained from meat. As used herein, ‘meat’ refers to edible parts (including blood) of animals including, but not limited to, domestic ungulates, poultry, lagomorphs, fish, wild game, farmed game, small wild game and large wild game, and generally corresponds to the definition of ‘meat’ in EU Regulation No. 853/2004. The protein source of the present invention may be referred to as “suitable for vegetarians”. The protein sources of the present invention may, however, be of animal origin. That is, protein source may comprise products not obtained from meat but obtained or derived from animal products. For example, protein source may comprise products obtained or derived from milk. Alternatively or additionally, protein source may comprise products obtained or derived from eggs, for example.

In other examples, though, the protein sources of the present invention are of non-animal origin. That is, they have not been obtained or derived from meat or any other product or constituent deriving from an animal, including milk, colostrum, eggs (namely, birds' eggs, in particular hens' eggs), beeswax, honey and propolis. Such protein sources may be referred to as “suitable for vegans”.

In some examples, the protein source may comprise hemp, whole algal protein, rice protein, pea protein, whey protein, soy protein, or a combination thereof. In further examples, the protein source may consist of hemp, whole algal protein, rice protein, pea protein, whey protein, soy protein, or a combination thereof.

Hemp is a variety of Cannabis sativa which is generally grown specifically for industrial uses. As used herein in relation to the protein source, ‘hemp’ refers to any part of the hemp plant including the leaf, stem, seed, or any product derived thereof, which has a protein content equal to or greater than 50%. In a preferred embodiment, hemp is provided as hemp powder, such as cold pressed hemp powder. Cold pressed hemp powder may have a protein content of approximately 50%, for example. For the avoidance of doubt, hemp products with a protein content of less than 50% (such as hulled hemp seeds) are not included as protein source.

‘Whole algal protein’ refers to a whole-food ingredient comprising dried algae biomass. The dried algae biomass may be ground or milled, and be provided in a particulate form corresponding to flour. Alternatively, an aqueous algal suspension may be lysed, and the resulting mass dried to provide whole algal protein in a particulate form corresponding to flour.

In some examples, the whole algal protein may have a protein content of greater than 50%, 55%, 60%, or 65%. In some examples, the whole algal protein may have a protein content of less than 90%, 80%, 70%, or 65%. In some examples, the whole algal protein may have a protein content of from 50 to 90%, or from 55 to 80%, or from 60 to 70%, or from 60 to 65%. Thus, whole algal protein is not included in the definition of “algal flour” or “algae flour” as described hereinabove.

Suitable algae for preparing the whole algal protein may belong to the genus Chlorella. Preferably, the alga is Chlorella protothecoides. In embodiments wherein the alga is Chlorella protothecoides, the alga is cultivated to provide whole algal protein according to a protocol different from that which is used to provide high-lipid algal flour (which is described hereinabove). For example, in the cultivation of whole algal protein, lipid production is not induced during the fermentation of the alga by limiting inorganic nitrogen.

The whole algal protein may be a GRAS ingredient. Suitable whole algal protein may be obtained from the vendor AlgaVia®. “AlgaVia® protein-rich algal flour” is suitable for use as whole algal protein in the present invention.

Rice protein may refer to protein concentrate, protein isolate, or a combination of protein concentrate and protein isolate obtained from rice. In some embodiments, the rice protein is brown rice protein, a protein concentrate, protein isolate, or a combination of protein concentrate and protein isolate obtained from brown rice. Brown rice protein may be provided by treating brown rice with enzymes to separate proteins from the carbohydrates therein. Brown rice protein may have a protein content of approximately 80%. Rice protein may be provided in powder form. For the avoidance of doubt, rice protein typically has a low starch content, and the presence of rice protein in the baked food product does not substantially contribute to the binding of the product.

Pea protein typically refers to protein concentrate, protein isolate, or a combination of protein concentrate and protein isolate obtained from pea, in particular, yellow peas, such as Pisum sativum. Pea protein may be provided in powder form. Pea protein concentrate may have a protein content of approximately 70%. Pea protein isolate may have a protein content of approximately 95%.

In some embodiments, the protein source comprises a combination of rice protein and pea protein.

Whey protein refers to the collection of globular proteins isolated from whey. Whey protein may be provided as whey protein concentrate, whey protein isolate, whey protein hydrosylates, or native whey protein, for example. Whey protein concentrate typically has a low level of fat and cholesterol but, in general, compared to the other forms of whey protein, has higher levels of bioactive compounds, and carbohydrates in the form of lactose. Whey protein concentrate may have a protein content of approximately 30 to 90% protein by weight. Whey protein isolate has been processed to remove fat and lactose, and is usually lower in bioactive compounds than whey protein concentrate. Whey protein isolate may have a protein content of greater than 90% by weight. Whey protein hydrosylates typically refer to whey proteins that are predigested and partially hydrolyzed for the purpose of easier metabolizing by the human body. Native whey protein is extracted from skimmed milk, unlike the other forms of whey protein listed herein above which are a byproduct of cheese production. Native whey protein may be provided in concentrate or isolate form.

Soy protein may be provided as soy flour, soy protein isolates and/or soy protein concentrates, for example. Soy flour or defatted soy flour may have a protein content of approximately 50%. Soy protein isolate may be obtained by aqueous extraction of defatted soy flour, and the term generally refers to a highly refined or purified form of soy protein with a minimum protein content of 90% by dry weight. Soy protein concentrate may be obtained by removing the water-soluble carbohydrates from dehulled and defatted soybeans, and typically has a protein content of at least 70% by dry weight.

In some embodiments, protein source may be provided in powder form (for example, as flour). In other embodiments, protein source may be provided in larger, particulate form (for example, as seeds).

In some embodiments, the protein source may be provided in powder form and have a mean particle size of greater than or equal to 0.1 μm, 1 μm, 10 μm, 50 μm, or 100 μm.

In some embodiments, the mean particle size of the protein source may be less than or equal to 500 μm, 250 μm, 100 μm, 50 μm, or 10 μm. In some embodiments, the mean particle size of the protein source may be from 0.1 μm to 500 μm, 1 μm to 250 μm, or 10 μm to 100 μm.

In other embodiments the protein source may be provided in particulate form and have a mean particle size greater than or equal to 0.5 mm, 0.75 mm, 1 mm, 1.5 mm, 2 mm, 2.5 mm, or 5 mm. In some embodiments, the mean particle size of the protein source may be less than or equal to 20 mm, 15 mm, 10 mm, 5 mm, 2.5 mm, 2 mm, 1.5 mm, or 1 mm. In some embodiments, the mean particle size of the protein source may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In embodiments wherein the protein source comprises a plurality of ingredients, each of the protein source ingredients may be provided in powder form and have a mean particle size greater than or equal to 0.1 μm, 1 μm, 10 μm, 50 μm, or 100 μm. In some embodiments, the mean particle size of each of the protein source ingredients may be less than or equal to 500 μm, 250 μm, 100 μm, 50 μm, or 10 μm. In some embodiments, the mean particle size of each of the protein source ingredients may be from 0.1 μm to 500 μm, 1 μm to 250 μm, or 10 μm to 100 μm.

In other embodiments wherein the protein source comprises a plurality of ingredients, the protein source ingredients may be provided in particulate form and have a mean particle size greater than or equal to 0.5 mm, 0.75 mm, 1 mm, 1.5 mm, 2 mm, 2.5 mm, or 5 mm. In some embodiments, the mean particle size of each of the protein source ingredients may be less than or equal to 20 mm, 15 mm, 10 mm, 5 mm, 2.5 mm, 2 mm, 1.5 mm, or 1 mm. In some embodiments, the mean particle size of each of the protein source ingredients may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In some embodiments, at least some of the protein source may be provided in powder form such that the particle size of at least 20%, 30%, 40%, 50%, 60%, 70%, 80%, or 90% of the protein source ingredients may be greater than or equal to 0.1 μm, 1 μm, 10 μm, 50 μm, or 100 μm. In some embodiments, the particle size of at least 20%, 30%, 40%, 50%, 60%, 70%, 80%, or 90% of the protein source ingredients may be less than or equal to 500 μm, 250 μm, 100 μm, 50 μm, or 10 μm. In some embodiments, the particle size of at least 20%, 30%, 40%, 50%, 60%, 70%, 80%, or 90% of the protein source ingredients may be from 0.1 μm to 500 μm, 1 μm to 250 μm, or 10 μm to 100 μm.

In other embodiments, at least some of the protein source may be provided in particulate form and the particle size of at least 20%, 30%, 40%, 50%, 60%, 70%, 80%, or 90% of the protein source ingredients may be greater than or equal to 0.5 mm, 0.75 mm, 1 mm, 1.5 mm, 2 mm, 2.5 mm, or 5 mm. In some embodiments, the particle size of at least 20%, 30%, 40%, 50%, 60%, 70%, 80%, or 90% of the protein source ingredients may be less than or equal to 20 mm, 15 mm, 10 mm, 5 mm, 2.5 mm, 2 mm, 1.5 mm, or 1 mm. In some embodiments, the particle size of at least 20%, 30%, 40%, 50%, 60%, 70%, 80%, or 90% of the protein source ingredients may be from 0.5 mm to 20 mm, 0.5 mm to 15 mm, 1 mm to 15 mm, 1.5 mm to 15 mm, 2 mm to 15 mm, 5 mm to 15 mm, or 5 mm to 10 mm.

In some examples, the protein source comprises protein concentrate and/or protein isolate. In some examples, the protein source consists of protein concentrate and/or protein isolate. In other examples, the protein source does not comprise protein concentrate and/or protein isolate.

In some examples, the protein source comprises whole-food ingredient(s). In some examples, the protein source consists of whole-food ingredients(s).

Other Food Ingredients

The baked food product may comprise further components, such as other food ingredients. Other food ingredients include flavourings, such as salt, sweeteners, herbs and spices. Suitable sweeteners for use in the present invention may include sucrose, glucose, stevia, lo han guo, xylitol, sorbitol, or a combination thereof. Sweeteners are, however, preferably not included in the baked food product according to the present invention. Suitable herbs and spices for use in the present invention may include asafoetida, basil, cardamom, cinnamon, cloves, coriander, cumin, fennel seeds, fenugreek, galangal, ginger, mustard, nutmeg, oregano, paprika, pepper (peppercorns), sage, star anise, rosemary, thyme, turmeric, wasabi, or a combination thereof. Said other food ingredients may constitute 0 to 10% of the baked food product by ingredient dry weight. Preferably, the other food ingredient may constitute 0 to 5% of the baked food product by ingredient dry weight.

Baked food products of the present invention may include gelling agents (the terms “binding agent” and “gelling agent” may be used interchangeably). Suitable gelling agent may include agars, alginates, carrageenans, gum Arabic, guar gum, locust bean gum, pectin, sodium CMC, xanthan gum, for example. In a preferred embodiment, the baked food product contains gelling agents in an amount of less than 5%, 4%, 3%, 2%, 1% gelling agent by dry weight. In a particularly preferred embodiment, the baked food product does not contain gelling agent.

Many conventional baked food products comprising wheat flour have a relatively high water activity (a_{w}). For example, the a_{w} of fresh bread may be around 0.95. Such a high water activity results in a short shelf-life, as such high moisture levels (>0.8, or >0.7) provide suitable environments for the growth of bacteria, yeasts and moulds.

Surprisingly, it has been found that equivalent baked products with lower water activities can be prepared with algae flour, whilst maintaining satisfactory flavour, mouthfeel, binding and texture. This may extend the shelf-life of these products. The algae flour may be used in part or entirely in place of grain flour of conventional baked food products. In some embodiments, the baked food product essentially does not comprise grain flour, in particular, the baked food product essentially does not comprise wheat flour. Baked food products according to the present invention may have a water activity of from 0.3 to 0.8, or from 0.3 to 0.7, or from 0.4 to 0.65, or from 0.5 to 0.6. In some embodiments, the baked food product has a water activity of less than 0.8, or less than 0.7, or less than 0.65, or less than 0.6, or less than 0.55. In some embodiments, the baked food product has a water activity of more than 0.3, or more than 0.4, or more than 0.5. Water activity can be measured a hygrometer, such as a resistive electrolytic hygrometer, capacitance hygrometer or dew point hygrometer. The water activity as referred to herein should be measured in accordance with NSF International Standard/American National Standard NSF/ANSI 75-2000 “Non-potentially hazardous foods” with measurement made at 25° C. Measurements can be made with a dew point hygrometer accurate to ±0.003 a_{w}, specifically the AquaLab Dew Point Water Activity Meter 4TE, available from Decagon Devices, Inc.

According to the present invention there may be provided a food product comprising fruit and/or vegetables with an extended shelf-life.

Further, according to the present invention there may be provided a baked food product which essentially does not comprise flour. Alternatively or additionally, there may be provided a baked food product which essentially does not comprise pulses. Alternatively or additionally, there may be provided a baked food product which essentially does not comprise nuts. Alternatively or additionally, there may be provided a baked food product which essentially does not comprise egg.

In some embodiments, the baked food product may be provided with a coating. Suitable coatings may include “yoghurt” coatings comprising sugar and palm oil, “chocolate” coatings comprising cocoa, vegetable oils/fats and sugar, or batter coatings, and the like. Coatings may be included to provide separation between each baked food product in a plurality of baked food products, or to enhance the organoleptic properties of the baked food product, or to provide protection for the baked food product, for example. For the avoidance of doubt, the components of a coating of a baked food product are not taken into account when defining the components of the baked food product; the components of a coating are in addition to the components of the baked food product of the present invention as defined herein.

Method of Manufacture

Baked food products according to the present invention may be manufactured according to any suitable method. In one embodiment, the method may comprise mixing fruit and/or vegetable ingredients with algae flour to afford a mixture. The mixture may then be formed into a food product shape, and then baked to afford a baked food product. Alternatively, the mixture may be baked to afford a baked material, and then formed into a food product shape to afford a baked food product.

In one embodiment, the method may comprise mixing fruit and/or vegetable ingredients in an amount of from 30 to 70% by dry weight with algae flour in an amount of from 10 to 45% by dry weight and protein source in an amount of from 15 to 50% by dry weight to form a mixture. All of the ingredients may be mixed together at substantially the same time. Alternatively, two ingredients may be mixed together (such as fruit and/or vegetable ingredients and algae flour, or fruit and/or vegetable ingredients and protein source, or algae flour and protein source), then the third ingredient mixed with the two already-mixed ingredients. The ingredients may be mixed in any order.

The mixture may then be formed into a food product shape, and then baked to afford a baked food product. Alternatively, the mixture may be baked to afford a baked material, and then formed into a product shape to afford a baked food product.

The mixture or baked material is formed into a food product shape(s). Said food product shapes may be regular or irregular. For example, regular food product shapes may include rectilinear bars, cylindrical bars, patties, wedges and wafers. Regular food product shapes may also include any shape which has been moulded (for instance, heart shapes, flower shapes, tree shapes etc.). Irregular food product shapes may include clusters, shards and drops. The food product shapes may be equal in size relative to each other, or unequal in size relative to each other. In one embodiment, the mixture or baked material is formed into regular, equal food product shape(s). In another embodiment, the mixture or baked material is formed into regular, unequal food product shape(s). In another embodiment, the mixture or baked material is formed into irregular, equal food product shape(s). In another embodiment, the mixture or baked material is formed into irregular, unequal food product shape(s).

The food product shape may be formed by any suitable method known in the art. Such methods include, but are not limited to, moulding, pressing, deposition, and extrusion. Some moulding methods can be carried out with a rotary moulder. Some pressing methods can be carried out with food forming machines, such as may be used to make a variety of food forms such as hamburger patties, and generally refers to a machine in which the mixture is pressed into a mould plate and then the food product shapes formed are subsequently knocked out of the mould. Some depositing methods can be carried out with a depositor. Some extrusion methods can be carried out with single screw extruders, twin screw extruders, or pelletizers. Shaping the mixture may also be carried out with food wire cut machines, sheet formers, or rotary cutters. More than one method and/or device for carrying out such a method may be used. In particular, forming the food product shape may first comprise any of the above methods (such as moulding, pressing, depositing or extruding), and then cutting the resulting shaped composition to provide a food product shape. In a particular embodiment, the mixture is baked to provide a baked material, and subsequently formed into a food product shape by cutting the baked material to provide a baked food product.

In one embodiment, the fruit and/or vegetables consist of particulate ingredients (such as entire, intact ingredients and/or cut, chopped, ground, grated ingredients) and liquidised ingredients. The liquidised ingredients may be purée or pulp of the fruit and/or vegetable ingredient, for example. In the case of tomato, the liquidised ingredient may be passata. The particulate ingredients may be fruit and/or vegetables in dehydrated form, or may be fruit and/or vegetables in a mix of dehydrated form and non-dehydrated form, or fruit and/or vegetables in non-dehydrated form. In this embodiment, the particulate ingredients may be combined with the algae flour and/or protein source first, and then that combination combined with the liquidised ingredients.

In these embodiments, the fruit and/or vegetable ingredients may comprise particulate and liquidised ingredients in any appropriate amount, including those amounts described hereinabove.

If there is insufficient moisture content in the ingredients to provide a workable mixture, then water may be added to the mixture to allow it to be worked and formed. In particular, water may be added to the mixture in embodiments wherein the fruit and/or vegetables do not include liquidised ingredients, or liquidised ingredients are present in a low amount.

The mixture provided by mixing fruit and/or vegetables with algae flour and protein source, and, if needed, adding water, may have any moisture level, for example, the mixture may have a moisture level of from 5 to 50%, or from 15 to 40%, or from 25 to 35%. This moisture level may be calculated from the measured moisture content of each of the starting materials, together with any added water.

The fat content of the algae flour may obviate the need to include further fat-containing components to the mixture to provide a baked food product with acceptable flavour, mouthfeel, binding and texture. Accordingly, the present invention may provide a method of manufacturing a baked food product which essentially does not comprise the addition of a fat component alongside the algae flour.

The mixture may be baked at any temperature and for any duration to afford a baked food product. A combination of suitable temperatures and durations may be readily determined by the skilled person. For example, the baking may be conducted at a temperature of from 30° C. to 150° C., or from 50 to 120° C., or from 50 to 100° C. In some embodiments, the baking may be conducted at a temperature of less than 150° C., or less than 120° C., or less than 100° C. In some embodiments, the baking may be conducted at a temperature of more than 30° C., or more than 50° C., or more than 60° C. or more than 70° C., or more than 80° C.

The baking may be carried out for a duration of from 60 mins to 1,800 mins, or from 90 to 900 mins, or from 120 to 300 mins. In some embodiments, baking may be carried out for a duration of more than 60 mins, or more than 90 mins, or more than 120 mins, or more than 180 mins. In some embodiments, the baking may be carried out for a duration of less than 1,800 mins, or less than 900 mins, or less than 300 mins.

After baking, the method may further include coating the baked food product to provide a coated baked food product. Suitable coatings may include “yoghurt” coatings comprising sugar and palm oil, “chocolate” coatings comprising cocoa mass and sugar, batter coatings, and the like. The coating may be applied to the baked food product by any suitable method according to the coating to be applied. For example, the coating may be applied by dredging, dipping, enrobing, panning, spraying, passing through a coating drum or belt coater. A coated baked food product may be considered to be a specific embodiment of a baked food product. In such an embodiment, the coating is not constitute a component of the baked food product; the components of the coating are in addition to the components of the baked food product.

### EXAMPLES

### Example 1

This is an example of a product wherein the protein source comprises hemp powder.

Ingredients:
2,498 g dehydrated carrot (10% water max=dry weight 2,248 g)
692 g dehydrated parsnip (10% water max=dry weight 622 g)
653 g dehydrated onion (6% water max=dry weight 614 g)
3,103 g AlgaVia® lipid-rich algal flour
3,164 g hemp protein powder (protein content=50%)
2,500 g passata (89.4% water max=dry weight 265 g)

The particulate ingredients (carrot, parsnip and onion) were mixed with the algal flour and hemp protein powder until combined. The liquidised ingredient (passata) was mixed through until combined with the particulate ingredients. The resulting mixture was transferred to a perforated baking sheet and baked at 90° C. for 3 hours 45 minutes. The baked mixture was then cut into food product bars.

### Example 2

This is an example of a product wherein the protein source comprises whole algal protein.

Ingredients:
2,946 g dehydrated carrot (10% water max=dry weight 2,651 g)
816 g dehydrated parsnip (10% water max=dry weight 734 g)
770 g dehydrated onion (6% water max=dry weight 724 g)
3,128 g AlgaVia® lipid-rich algal flour
2,449 g whole algal protein (protein content=63%)
2,500 g passata (89.4% water max=dry weight 265 g)

The particulate ingredients (carrot, parsnip and onion) were mixed with the algal flour and whole algal protein until combined. The liquidised ingredient (passata) was mixed through until combined with the particulate ingredients. The resulting mixture was transferred to a perforated baking sheet and baked at 90° C. for 3 hours 45 minutes. The baked mixture was then cut into food product bars.

### Example 3

This is another example of a product wherein the protein source comprises whole algal protein.

Ingredients:
3,586 g dehydrated carrot (10% water max=dry weight 3,228 g)
993 g dehydrated parsnip (10% water max=dry weight 894 g)
938 g dehydrated onion (6% water max=dry weight 882 g)
2,143 g AlgaVia® lipid-rich algal flour
2,449 g whole algal protein (protein content=63%)
2,500 g passata (89.4% water max=dry weight 265 g)

The particulate ingredients (carrot, parsnip and onion) were mixed with the algal flour and whole algal protein until combined. The liquidised ingredient (passata) was mixed through until combined with the particulate ingredients. The resulting mixture was transferred to a perforated baking sheet and baked at 90° C. for 3 hours 45 minutes. The baked mixture was then cut into food product bars.

### Example 4

This is another example of a product wherein the protein source comprises whole algal protein.

Ingredients:
4,227 g dehydrated carrot (10% water max=dry weight 3,804 g)
1,170 g dehydrated parsnip (10% water max=dry weight 1,053 g)
1,105 g dehydrated onion (6% water max=dry weight 1,039 g)
1,158 g AlgaVia® lipid-rich algal flour
2,449 g whole algal protein (protein content=63%)
2,500 g passata (89.4% water max=dry weight 265 g)

The particulate ingredients (carrot, parsnip and onion) were mixed with the algal flour and whole algal protein until combined. The liquidised ingredient (passata) was mixed through until combined with the particulate ingredients. The resulting mixture was transferred to a perforated baking sheet and baked at 90° C. for 3 hours 45 minutes. The baked mixture was then cut into food product bars.

### Example 5

This is an example of a product wherein the protein source comprises brown rice protein.

Ingredients:
3,330 g dehydrated carrot (10% water max=dry weight 2,997 g)
922 g dehydrated parsnip (10% water max=dry weight 830 g)
871 g dehydrated onion (6% water max=dry weight 819 g)
3,149 g AlgaVia® lipid-rich algal flour
1,837 g brown rice protein (protein content=80%)
2,500 g passata (89.4% water max=dry weight 265 g)

The particulate ingredients (carrot, parsnip and onion) were mixed with the algal flour and brown rice protein until combined. The liquidised ingredient (passata) was mixed through until combined with the particulate ingredients. The resulting mixture was transferred to a perforated baking sheet and baked at 90° C. for 3 hours 45 minutes. The baked mixture was then cut into food product bars.

### Example 6

This is another example of a product wherein the protein source comprises brown rice protein.

Ingredients:
3,970 g dehydrated carrot (10% water max=dry weight 3,573 g)
1,100 g dehydrated parsnip (10% water max=dry weight 990 g)
1,038 g dehydrated onion (6% water max=dry weight 976 g)
2,164 g AlgaVia® lipid-rich algal flour
1,837 g brown rice protein (protein content=80%)
2,500 g passata (89.4% water max=dry weight 265 g)

The particulate ingredients (carrot, parsnip and onion) were mixed with the algal flour and brown rice protein until combined. The liquidised ingredient (passata) was mixed through until combined with the particulate ingredients. The resulting mixture was transferred to a perforated baking sheet and baked at 90° C. for 3 hours 45 minutes. The baked mixture was then cut into food product bars.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A baked food product consisting of:
from 10 to 45% by dry ingredient weight algae flour, wherein the algae flour has a protein content of less than 50%;
from 30 to 70% by dry ingredient weight fruit and/or vegetables;
from 15 to 50% by dry ingredient weight protein source, wherein the protein source has a protein content of greater than or equal to 50% and is of non-meat origin; and
less than 10% by dry ingredient weight other food ingredients;
wherein the baked food product has a protein content greater than 15%, and has a water activity of less than 0.8.

2. A baked food product according to claim 1, wherein the baked food product is made from fruit and/or vegetable ingredients in particulate form in an amount of greater than or equal to 20% by dry weight of the fruit and/or vegetable ingredients.

3. A baked food product according to any of the preceding claims, wherein the baked food product has a sugar content of less than 50% by dry weight.

4. A baked food product according to any of the preceding claims, wherein the protein source comprises hemp, whole algal protein, rice protein (including brown rice protein), pea protein, whey protein (including whey protein isolate), soy protein (including soy protein isolate), or a combination thereof.

5. A baked food product according to any of the preceding claims, wherein the protein source is of non-animal origin.

6. A baked food product according to any of the preceding claims, wherein the fruit and/or vegetables include seeds in an amount of from 0 to 30% by dry weight of the fruit and/or vegetables.

7. A baked food product according to any of the preceding claims, wherein the fruit and/or vegetables contain fruit in an amount of less than 50% by dry weight of the fruit and/or vegetables.

8. A baked food product according to any of the preceding claims, wherein the fruit and/or vegetables consist of vegetables.

9. A baked food product according to any of the preceding claims, wherein the vegetables are selected from butternut squash, carrot, onion, parsnip, bell pepper, chili pepper, tomato, artichoke, asparagus, avocado, broccoli, cauliflower, potato, sweet potato, yam, pumpkin, marrow (including courgette), aubergine, cucumber, spring onion, chive, garlic, leek, beetroot, celery, endive, spinach, kale, seaweed, cabbage, Brussels sprouts, watercress, chard, fennel, olive, and combinations thereof.

10. A baked food product according to any of claims 1 to 7, wherein the fruit are selected from cranberry, goji berry, grape, cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate, and combinations thereof.

11. A baked food product according to any of the preceding claims, wherein the baked food product does not comprise wheat flour.

12. A baked food product according to any of the preceding claims, wherein the baked food product does not comprise egg.

13. A baked food product according to any of the preceding claims, wherein the baked food product does not comprise a binding/gelling agent.

14. A baked food product according to any of the preceding claims, wherein the baked food product has a water activity of less than 0.7.

15. A baked food product according to any of the preceding claims, wherein the baked food product is further provided with a coating.

16. A method of making a baked food product with a protein content of greater than 15%, the method comprising the steps of:
(a) mixing fruit and/or vegetable ingredients in an amount of from 30 to 70% by dry weight with algae flour in an amount of from 10 to 45% by dry weight and protein source in an amount of from 15 to 50% by dry weight to afford a mixture, wherein the protein source has a protein content greater than or equal to 50% and is of non-meat origin; and
(b) baking the mixture to afford a baked material having a water activity of less than 0.8;
wherein the mixture or baked material is formed into a food product shape before or after step (b) respectively, thereby providing a baked food product.

17. A method according to claim 16, wherein the mixture is formed into the food product shape before step (b).

18. A method according to claim 16, wherein the baked material is formed into the food product shape after step (b).

19. A method according to any of claims 16 to 18, wherein the fruit and/or vegetable ingredients consist of particulate ingredients and liquidised ingredients, and, in step (a), the particulate ingredients are first combined with the algae flour and protein source, and then the liquidised ingredients are added.

20. A method according to any of claims 16 to 18, wherein the fruit and/or vegetable ingredients consist of particulate ingredients.

21. A method according to any of claims 16 to 20, wherein the vegetable ingredients are selected from butternut squash, carrot, onion, parsnip, bell pepper, chili pepper, tomato, artichoke, asparagus, avocado, broccoli, cauliflower, potato, sweet potato, yam, pumpkin, marrow (including courgette), aubergine, cucumber, spring onion, chive, garlic, leek, beetroot, celery, endive, spinach, kale, seaweed, cabbage, Brussels sprouts, watercress, chard, fennel, olive, and combinations thereof.

22. A method according to any of claims 16 to 21, wherein the fruit ingredients are selected from cranberry, goji berry, grape, cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate, and combinations thereof.

23. A method according to any of claims 16 to 22, wherein the protein source comprises hemp, whole algal protein, brown rice protein, pea protein, whey protein (including whey protein isolate), soy protein (including soy protein isolate), or a combination thereof.

24. A method according to any of claims 16 to 23, wherein the baking is conducted at a temperature of from 30° C. to 150° C. and for a duration of from 60 mins to 1,800 mins.

25. A method according to any of claims 16 to 24, wherein the mixture has a moisture level of from 5 to 50%.
